(19) United States
(12) Patent Application Publication
(10) Pub. No.: US 2023/0245046 A1
(43) Pub. Date: Aug. 3, 2023

(54) SYSTEMS AND METHODS FOR PREDICTING WHEN A SHIPPING STORAGE CONTAINER IS CLOSE AND READY FOR DISPATCH

(71) Applicant: Walmart Apollo, LLC, Bentonville, AR (US)

(72) Inventors: Jitin Chemmannur, Bentonville, AR (US); Kasyap Vissapragada Jagannatha Sri, Bentonville, AR (US); Matthew G. McCleskey, Rogers, AR (US); Rodrigo Rangel, Rogers, AR (US); Shivam Kumar Jakhanwal, Kent, WA (US)

(21) Appl. No.: 17/588,819

(22) Filed: Jan. 31, 2022

(51) Int. Cl. G06Q 10/08; G06K 9/62; G06N 20/00

(52) U.S. Cl. CPC G06Q 10/08355; G06K 9/6256; G06N 20/00; G06Q 10/0831; G06Q 10/0833

(57) ABSTRACT

In some embodiments, apparatuses and methods are provided herein useful to predicting when a shipping storage container is closed and ready to be dispatched. In some embodiments, there is provided a system for predicting when a shipping storage container is closed and ready to be dispatched from a storage facility includes a database, a memory; and a control circuit. The control circuit configured to execute a computer-implemented code to receive a set of shipping units data; group the set of shipping data into size data; determine a count of each of the one or more sizes of the shipping units; determine an estimated time when the shipping storage container will be ready for dispatch; and transmit a notification indicating the estimated time to an electronic device associated with a carrier to cause the carrier to start preparation to pick up the shipping storage container at the storage facility.

### TECHNICAL FIELD

This invention relates generally to the loading of shipping storage containers at a storage facility, and more specifically to determining when a shipping storage container is ready for dispatch at the storage facility.

### BACKGROUND

Generally, a customer submits an order from a retailer and the retailer fulfill this order at a fulfillment center. In fulfilling this order along with a number of orders from several customers, the faster the order is fulfilled, the sooner the customers get the products they ordered. However, there is quite a considerable delay when an outbound trailer is closed and ready for dispatch from a fulfillment center and when a carrier actually receives or picks up the trailer. The resulting delay leads to inefficiencies the dispatching of trailers, e.g., trailers ready for dispatch are not timely picked up by carriers and/or there is delay is providing a new trailer to be loaded at the fulfillment center.

### BRIEF DESCRIPTION OF THE DRAWINGS

Disclosed herein are embodiments of systems, apparatuses and methods pertaining to predicting when a shipping storage container is closed and ready to be dispatched from a storage facility. This description includes drawings, wherein:

FIG. 1 illustrates a simplified block diagram of an exemplary system for predicting when an outbound shipping storage container is closed and ready to be dispatched from a storage facility such as a fulfilment center or a distribution center in accordance with some embodiments;

FIG. 2 illustrates an exemplary percentile table for predicting when a shipping storage container is closed and ready to be dispatched from a storage facility in accordance with some embodiments;

FIG. 3 is a simplified schematic illustration for predicting when a shipping storage container is closed and ready to be dispatched from a storage facility in accordance with some embodiments;

FIG. 4 shows a flow diagram of an exemplary process of predicting when a shipping storage container is closed and ready to be dispatched from a storage facility in accordance with some embodiments; and

FIG. 5 illustrates an exemplary system for use in implementing methods, techniques, devices, apparatuses, systems, servers, sources and predicting when a shipping storage container is closed and ready to be dispatched from a storage facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for predicting when a shipping storage container is closed and ready to be dispatched from a storage facility, such as a storage facility operated by or under control by a commercial product retailer, e.g., a fulfillment center or a distribution center. In some embodiments, a system for predicting when a shipping storage container is closed and ready to be dispatched from a storage facility includes a database storing data including shipping container data and shipping units data. The system includes a memory storing a computer-implemented code including a trained machine learning model. The system includes a control circuit coupled to the database and the memory. The control circuit executes the computer implemented code to receive a set of shipping units data corresponding to the shipping storage container to be loaded with shipping units before the shipping storage container can be dispatched from the storage facility. Alternatively or in addition to, the control circuit executes the computer implemented code to group, using the trained machine learning model, the set of shipping data into size data, the size data indicating one or more sizes of the shipping units. Alternatively or in addition to, the control circuit executes the computer implemented code to determine, using the trained machine learning model, a count of each of the one or more sizes of the shipping units. Alternatively or in addition to, the control circuit executes the computer implemented code to determine, using the trained machine learning model and the count, an estimated time when the shipping storage container will be ready for dispatch. Alternatively or in addition to, the control circuit executes the computer implemented code to transmit a notification indicating the estimated time to an electronic device associated with a carrier to cause the carrier to start preparation to pick up the shipping storage container at the storage facility.

In some embodiments, a computer-implemented method for predicting when a shipping storage container is closed and ready to be dispatched from a storage facility includes receiving, at a control circuit, a set of shipping units data corresponding to the shipping storage container to be loaded with shipping units before the shipping storage container can be dispatched from the storage facility. Alternatively or in addition to, the method includes grouping, using a trained machine learning model of the control circuit, the set of shipping data into size data, the size data indicating one or more sizes of the shipping units. Alternatively or in addition to, the method includes determining, using the trained machine learning model, a count of each of the one or more sizes of the shipping units. Alternatively or in addition to, the method includes determining, using the trained machine learning model and based at least on the count, an estimated time when the shipping storage container will be ready for dispatch. Alternatively or in addition to, the method includes transmitting a notification indicating the estimated time to an electronic device associated with a carrier to cause the carrier to start preparation to pick up the shipping storage container at the storage facility.

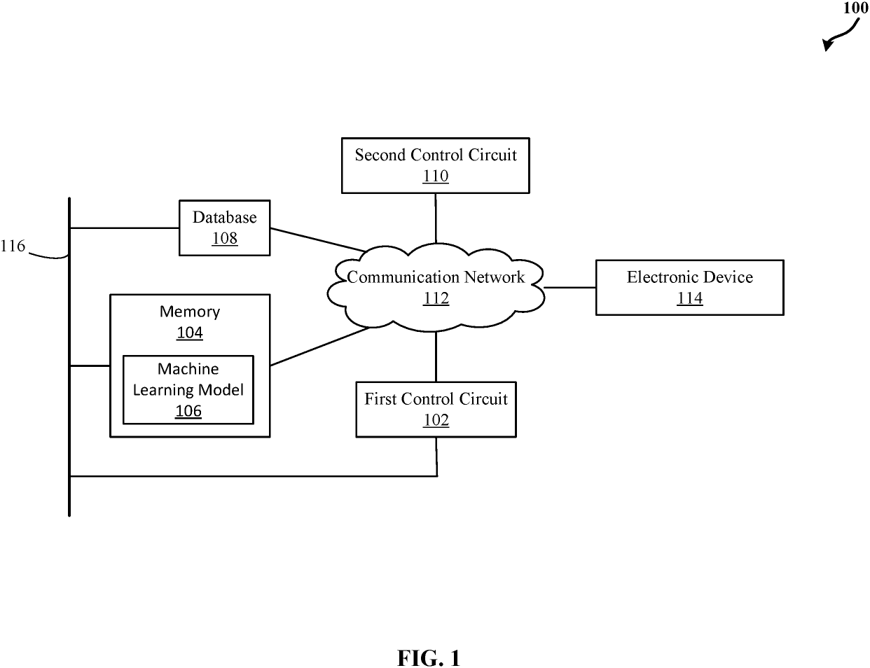

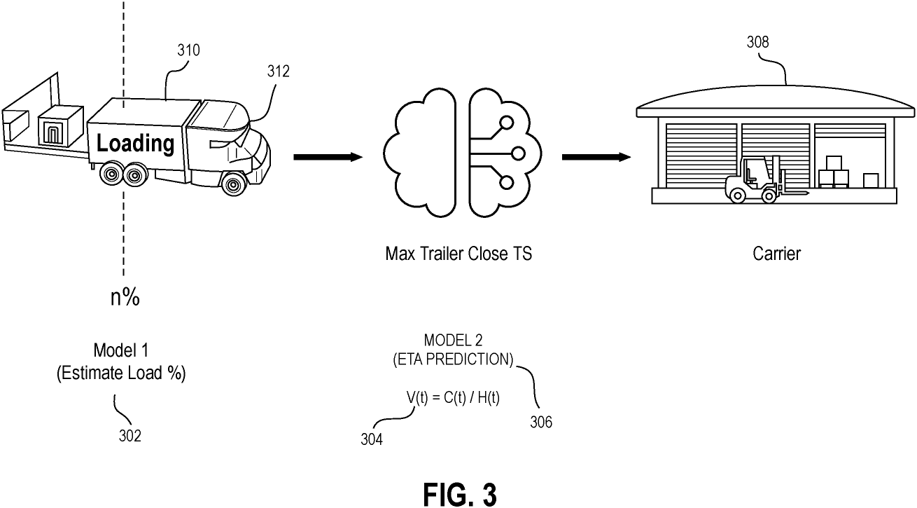

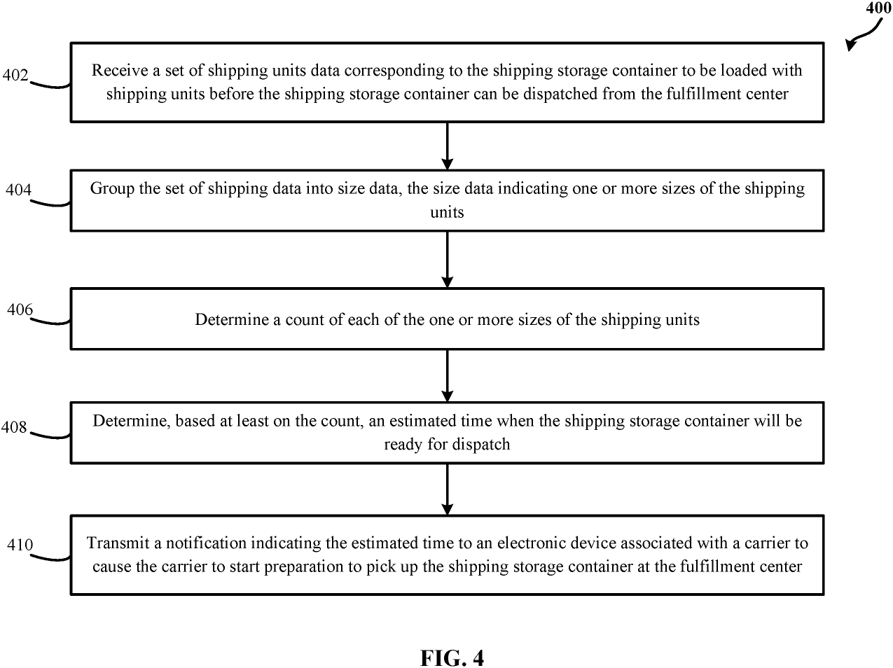

FIGS. 1 and 4 are concurrently described. FIG. 1 illustrates a simplified block diagram of an exemplary system 100 for predicting when an outbound shipping storage container is closed and ready to be dispatched from a storage facility in accordance with some embodiments. FIG. 4 shows a flow diagram of an exemplary process/method 400 of predicting when a shipping storage container is closed and ready to be dispatched from a storage facility in accordance with some embodiments. FIG. 3 shows a simplified diagram illustrating a trailer 310 being loaded at a storage facility. When the trailer is filled and closed, it is ready for be dispatched and transported by a carrier (e.g., a shipping/last mile company, agent, provider) to its intended location. For example, as shown in FIG. 3, a vehicle 312 attaches to the trailer 310 and driver drives the vehicle 312 and trailer 310 away from the storage facility. Problems occur when a trailer is ready for dispatch but the vehicle 312 is not connected and/or a driver is not available to drive the vehicle 312. Such delay results in down times at loading docks and delays in positioning the next trailer to be loaded. And less products are transported from the storage facility every day. Some embodiments predict when a particular shipping storage container will be closed and ready for dispatch so that the trailer can be promptly driven away for the vehicle 312. In some embodiments, trained machine learning models are used to make such predictions. It is understood that containers are to be moved from storage facilities. In some embodiments, storage facilities may be associated with or owned and controlled by commercial product retailer entities. In some embodiments, storage facilities may be fulfillment centers, distribution centers, retail stores and/or combinations of such facilities.

In some embodiments, the system 100 includes a database 108 storing data including shipping container data and shipping units data. In some embodiments, the shipping units data includes sizes of shipping units, a quantity of shipping units, total weight of shipping units, total volume of shipping units, a day of a week, a week of a year, and/or a number of scheduled dispatch appointments to create each corresponding quantity data, total weight data, total volume data, day data, week data, and/or number of scheduled dispatch appointment data. In some embodiments, a size of a shipping unit includes a small, a medium, and/or a large. In some embodiments, a shipping unit includes a box including products/items associated with a purchase order and/or a pallet including boxes and/or products/items associated with one or more purchase orders, to name a few. In some embodiments, the shipping units corresponds to at least one of first units already loaded in the shipping storage container and/or second units not loaded in the shipping storage container. In some embodiments, a shipping storage container includes a trailer. In some embodiments, a shipping container data includes a destination (for example, an address, a location, a facility, and/or a retailer, etc.), a receiving carrier, a load identification, and/or a distribution center identification, to name a few.

Alternatively or in addition to, the system 100 includes a memory 104 storing a computer-implemented code including a trained machine learning model 106. In some embodiments, the memory 104 includes a cloud, a hard drive, a state drive, a storage system, a random access memory, a read only memory, a database, and/or any memory storage devices capable of storing electronic data. By one approach, the memory 104 and/or a database 108 may be coupled to the first control circuit 102 and/or a second control circuit 110 via a communication network 112 (for example, the Internet and/or one or more wired and/or wireless communication networks) and/or a communication bus 116. Alternatively or in addition to, the system 100 includes a control circuit 102. In some embodiments, the control circuit 102 is coupled to the database 108 and/or the memory 104. The control circuit 102 executes the computer implemented code to receive, at step 402, a set of shipping units data corresponding to the shipping storage container to be loaded with shipping units before the shipping storage container can be dispatched from the storage facility. Alternatively or in addition to, at step 404, the control circuit 102 executes the computer implemented code to group, using the trained machine learning model 106, the set of shipping data into size data, the size data indicating one or more sizes of the shipping units. Alternatively or in addition to, the control circuit 102 may execute the computer-implemented code to further group, using the trained machine learning model 106, the data into at least one of a quantity of the shipping units, total weight of the shipping units, total volume of the shipping units, a day of a week, the week of a year, and a number of scheduled dispatch appointments to create each corresponding quantity data, total weight data, total volume data, day data, week data, and number of scheduled dispatch appointment data.

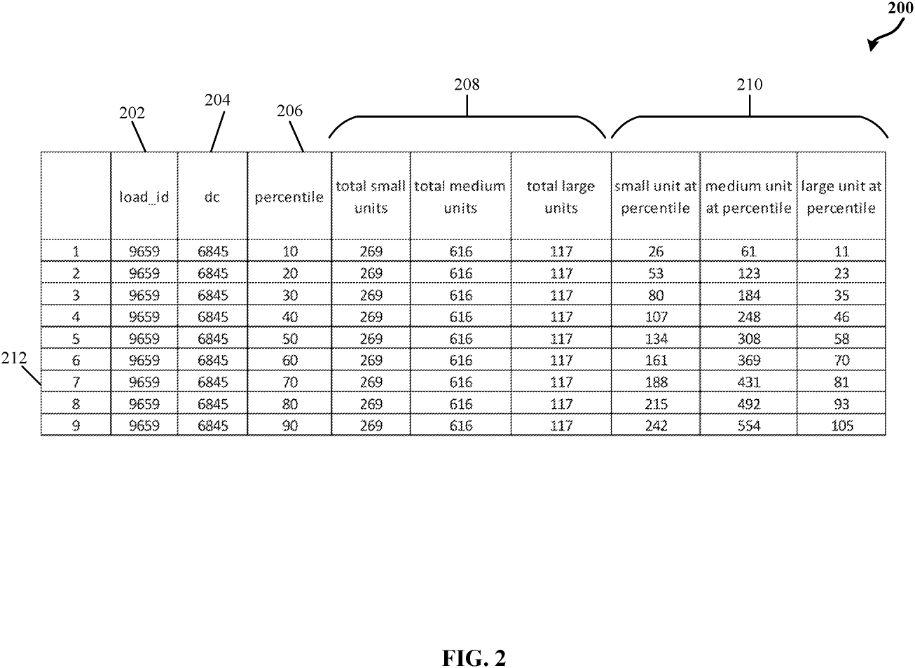

Alternatively or in addition to, at step 406, the control circuit 102 executes the computer implemented code to determine, using the trained machine learning model 106, a count of each of the one or more sizes of the shipping units. Alternatively or in addition to, at step 408, the control circuit 102 executes the computer implemented code to determine, using the trained machine learning model 106 and the count, an estimated time when the shipping storage container will be ready for dispatch. Alternatively or in addition to, the control circuit 102 may execute the computer-implemented code to further determine the estimated time using a predetermined percent value of a percentile table. In an illustrative non-limiting example, a percentile table 200 is shown in FIG. 2. In some embodiments, the percentile table 200 includes one or more of the following columns: load_id 202, distribution center 204, percentile 206, total small, medium, and/or large units 208, and/or small, medium, and/or large unit at percentile 210. In some embodiments, the predetermined percent value may correspond to a respective percentage that the shipping storage container is loaded with the shipping units relative to a total quantities of the shipping units to be loaded. In an illustrative non-limiting example, at row 212 of FIG. 2, the predetermined percent value is 70% and at 70%, the shipping storage container is approximately 70% loaded, such that a total of 700 shipping units are loaded out of 1002 shipping units planned and/or to be loaded into the shipping storage container. In some embodiments, the percentile table 200 includes a percentile range. Alternatively or in addition to, the percentile table 200 may include one or more individual values. In some embodiments, each percent value in the percentile range is a factor of ten relative to other values in the percentile range as shown in FIG. 2 (for example, 10, 20, 30, 40, 50, 60, 70, 80, 90, 100). Alternatively or in addition to, each percent value in the percentile range may include a factor other than ten, such as two, three, five (for example, 5, 10, 15, 20, 25, 30, 35, 40, 45, 50, 55, 60, 65, 70, 75, 80, 85, 90, 95, 100), fifteen, twenty (for example, 20, 40, 60, 80, 100), etc., to name a few.

Alternatively or in addition to, at step 410, the control circuit 102 executes the computer implemented code to transmit a notification indicating the estimated time to an electronic device 114 associated with a carrier to cause the carrier to start preparation to pick up the shipping storage container at the storage facility. In some embodiments, an electronic device 114 includes a smartphone, a tablet, a display unit associated with a vehicle, a computer, and/or a server, to name a few. Alternatively or in addition to, the control circuit 102 executes the computer implemented code to transmit a second notification to the electronic device 114 indicating an actual time that the shipping storage container is closed and/or ready to be dispatched from the storage facility. Alternatively or in addition to, the second control circuit 110 assigns a confidence level corresponding to a difference between the estimated time and the actual time the shipping storage container is ready for dispatch. In some embodiments, a difference between an estimated time and an actual time the shipping storage container is ready for dispatch may be determined by the second control circuit 110 over a period of time to determine a corresponding confidence level to associate for a particular percent value in the percentile table 200. In some embodiments, a confidence level may correspond to how accurate or how close the machine learning model’s estimated time relative to the actual time the shipping storage container is closed and/or ready to be dispatched.

Alternatively or in addition to, the second control circuit 110, for each percent value in the percentile range, may associate the confidence level with a respective percentage that the shipping storage container is loaded with the shipping units relative to the total quantities of the shipping units to be loaded. Alternatively or in addition to, the second control circuit 110 may update the percentile table 200 based on the associated confidence level. For example, a transmission of a notification indicating the estimated time is based in part on the associated confidence level.

In some embodiments, the machine learning model described in the system 100 of FIG. 1 and/or the method 400 of FIG. 4 may be a single trained machine learning model. In some embodiments, the machine learning model described in the system 100 of FIG. 1 and/or the method 400 of FIG. 4 may include two or more separate trained machine learning models (for example, model 1 and model 1 as shown in FIG. 3). FIG. 3 is a simplified schematic illustration for predicting when a shipping storage container is closed and ready to be dispatched from a storage facility 308 in accordance with some embodiments. In an illustrative non-limiting example, the estimating of a percentage complete that a shipping storage container is loaded with the shipping units at any point in time may be performed using a first machine learning model 302. As described herein, the first machine learning model 302 may be trained using input data associated with a set of shipping units data. In some embodiments, a size data indicating one or more sizes of shipping units are at least input to train the first machine learning model 302.

As shown in FIG. 2, in some embodiments, the prediction of a time the shipping storage container is closed and/or ready to be dispatched from a storage facility may be performed using a second machine learning model 306. In some embodiments, the second machine learning model 306 may be trained to determine a velocity of loading (V(t)) based on a relative ratio between a percentage complete (C(t)) at time (t) and a total active time (H(t)) at the time (t) of the shipping storage container. In some embodiments, the velocity of loading (V(t)) may correspond to equation 304 of FIG. 3. In some embodiments, the second machine learning model 306 may receive an input from the first machine learning model 302 of the estimated percent complete of the shipping units loaded in the shipping storage container. Alternatively or in addition to, the second machine learning model 306 may be trained using the input from the first machine learning model 302 and the determined velocity of loading (V(t)) to determine an estimated time that the shipping storage container is closed and ready to be dispatched from the storage facility 308. As such, the control circuit 102 may then transmit a notification to a carrier of the estimated time in order for the carrier to start preparing to pick up the shipping storage container at the storage facility 308, thereby reducing and/or avoiding delay and/or inefficiency of when a shipping storage container is received or picked up the carrier. One of the resulting benefits is that ordered items/products are received much sooner than conventional by customers.

Moreover, a reference to a machine learning model may be interchangeable with a reference to a neural network. A person ordinary skilled in the art would know that a neural network is an advanced application of machine learning and that present disclosures are both applicable to a trained neural network and a trained machine learning. Additionally, in executing a trained neural network and/or a trained machine learning model, the first control circuit 102 may be executing and/or using one or more models trained as described herein. Moreover, the neural network and/or the machine learning model and/or algorithm may include a supervised learning, an unsupervised learning and/or reinforcement learning. In some embodiments, the neural network and/or the machine learning model and/or algorithm may include Linear Regression, Support Vector Machine, Naive Bayes, Logistic Regression, K-Nearest Neighbors (kNN), Decision Trees, Random Forest, Gradient Boosted Decision Trees (GBDT), K-Means Clustering, Hierarchical Clustering, DBSCAN Clustering, and/or Principal Component Analysis (PCA), to name a few.

For example, Random Forest itself is a tree-based algorithm that is used to solve both classification and regression tasks. It also an ensembled method, meaning that a random forest is made up of many decision trees (estimators), where each decision produces their own prediction. In some embodiments, a decision tree itself may be weak for a couple of reasons: (1) the estimator tends to overfit, models the noise rather than the pattern; (2) very unstable, very small changes to the data will result in large structural changes to the decision tree. In some embodiments, there are three reasons which makes Random Forest stronger than a decision tree algorithm. The first reason is that it creates N number of trees (usually 100-1000 tree range). The second reason is that each decision tree itself will produce a results, and thus Random Forest will take the average of all trees (ensemble) and create one single robust prediction (more stable). The third reason is that Random Forest uses bootstrap sampling, random sampling with replacement. Each decision tree is built from a subset of the training dataset, thus reducing any over-fitting of the model. These three reasons together are called bagging.

In some embodiments, the control circuit 102 (or the first control circuit) and/or the second control circuit 110 may collect and/or store a determined estimated time and a corresponding actual time when a shipping storage container is closed and ready to be dispatched. In some embodiments, the control circuit 102 (or the first control circuit) and/or the second control circuit 110 may determine a difference between the determined estimated time and the corresponding actual time to determine the accuracy of the determined estimated time. In some embodiments, the trained neural network and/or the trained machine learning model and/or algorithm may be periodically and/or continuously improved by retraining based on the collected and/or stored determined estimated time and corresponding actual time and/or the determined difference. In some embodiments, the neural network and/or the machine learning model and/or algorithm may be trained using input data based on a set of shipping data transformed into a size data, a quantity of shipping units, total weight of shipping units, total volume of shipping units, a day of a week, a week of a year, and/or a number of scheduled dispatch appointments to create each corresponding quantity data, total weight data, total volume data, day data, week data, and/or number of scheduled dispatch appointment data. In some embodiments, the control circuit 102 (or the first control circuit) and the second control circuit 110 may be the same control circuit. In some embodiments, the control circuit 102 (or the first control circuit) and the second control circuit 110 may be two separate and distinct control circuits.

The models described herein are trained by going through the same analysis as described for the execution of the model. The models are trained with multiple sets of data inputs corresponding to known and/or fictitious events with and/or without manual feedback to fine tune the identification/similarity analysis and/or scoring/weighting. Once the models provide consistent analysis with a given confidence level, the trained models are saved for use by the system in real time. Occasionally, the models can be re-trained or training can be supplemented with additional training examples and/or data sets and with user feedback during real time usage. In some embodiments, collected and/or received event data are transformed into one or more formats to facilitate training of the machine learning model 106. In some embodiments, the machine learning model 106 may be trained in one or more stages. Each stage may output a particular trained model. In some embodiments, a trained model may be further trained in a subsequent stage based on another data set as input.

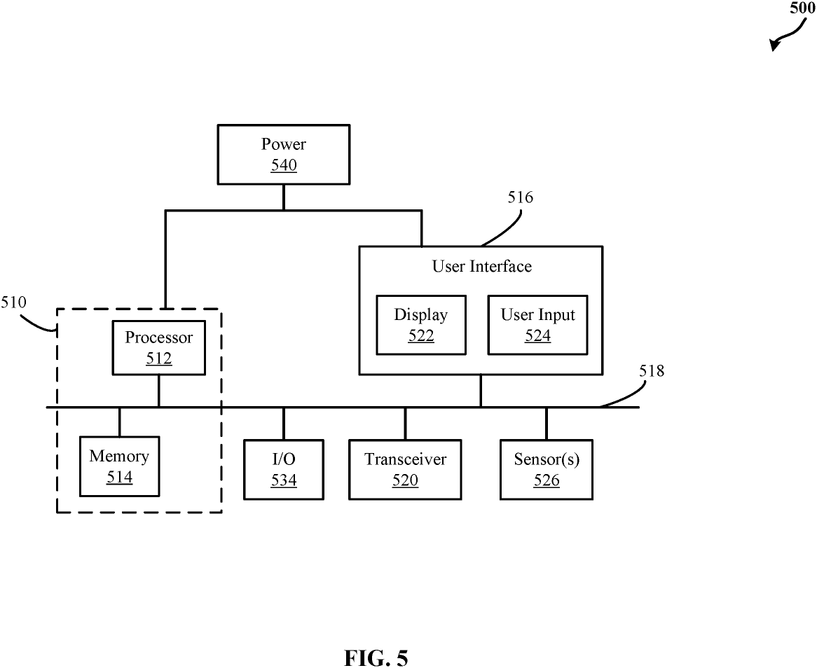

Further, the circuits, circuitry, systems, devices, processes, methods, techniques, functionality, services, servers, sources and the like described herein may be utilized, implemented and/or run on many different types of devices and/or systems. FIG. 5 illustrates an exemplary system 500 that may be used for implementing any of the components, circuits, circuitry, systems, functionality, apparatuses, processes, or devices of the system 100 of FIG. 1, the method 400 of FIG. 4, and/or other above or below mentioned systems or devices, or parts of such circuits, circuitry, functionality, systems, apparatuses, processes, or devices. For example, the system 500 may be used to implement some or all of the system for predicting when a shipping storage container is closed and ready to be dispatched from a storage facility, the control circuit 102 (or the first control circuit 102), the second control circuit 110, the database 108, the memory 104, the communication network 112, the electronic device 114, and/or other such components, circuitry, functionality and/or devices. However, the use of the system 500 or any portion thereof is certainly not required.

By way of example, the system 500 may comprise a processor module (or a control circuit) 512, memory 514, and one or more communication links, paths, buses or the like 518. Some embodiments may include one or more user interfaces 516, and/or one or more internal and/or external power sources or supplies 540. The control circuit 512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 512 can be part of control circuitry and/or a control system 510, which may be implemented through one or more processors with access to one or more memory 514 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like. For example, the system 500 may implement the system for predicting when a shipping storage container is closed and ready to be dispatched from a storage facility with the control circuit 102 being the control circuit 512.

The user interface 516 can allow a user to interact with the system 500 and receive information through the system. In some instances, the user interface 516 includes a display 522 and/or one or more user inputs 524, such as buttons, touch screen, track ball, keyboard, mouse, etc., which can be part of or wired or wirelessly coupled with the system 500. Typically, the system 500 further includes one or more communication interfaces, ports, transceivers 520 and the like allowing the system 500 to communicate over a communication bus, a distributed computer and/or communication network (e.g., a local area network (LAN), the Internet, wide area network (WAN), etc.), communication link 518, other networks or communication channels with other devices and/or other such communications or combination of two or more of such communication methods. Further the transceiver 520 can be configured for wired, wireless, optical, fiber optical cable, satellite, or other such communication configurations or combinations of two or more of such communications. Some embodiments include one or more input/output (I/O) interface 534 that allow one or more devices to couple with the system 500. The I/O interface can be substantially any relevant port or combinations of ports, such as but not limited to USB, Ethernet, or other such ports. The I/O interface 534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 526 to provide information to the system and/or sensor information that is communicated to another component, such as the control circuit 102 (or the first control circuit 102), the second control circuit 110, the database 108, the memory 104, the communication network 112, the electronic device 114, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 500 comprises an example of a control and/or processor-based system with the control circuit 512. Again, the control circuit 512 can be implemented through one or more processors, controllers, central processing units, logic, software and the like. Further, in some implementations the control circuit 512 may provide multiprocessor functionality.

The memory 514, which can be accessed by the control circuit 512, typically includes one or more processor readable and/or computer readable media accessed by at least the control circuit 512, and can include volatile and/or nonvolatile media, such as RAM, ROM, EEPROM, flash memory and/or other memory technology. Further, the memory 514 is shown as internal to the control system 510; however, the memory 514 can be internal, external or a combination of internal and external memory. Similarly, some or all of the memory 514 can be internal, external or a combination of internal and external memory of the control circuit 512. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 514 can store code, software, executables, scripts, data, content, lists, programming, programs, log or history data, user information, customer information, product information, and the like. While FIG. 5 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for predicting when a shipping storage container is closed and ready to be dispatched from a storage facility, the system comprising:
a database storing data comprising shipping container data and shipping units data;
a memory configured to store a computer-implemented code comprising a trained machine learning model; and
a control circuit coupled to the database and the memory and configured to execute the computer-implemented code to:
receive a set of shipping units data corresponding to the shipping storage container to be loaded with shipping units before the shipping storage container can be dispatched from the storage facility;
group, using the trained machine learning model, the set of shipping units data into size data, the size data indicating one or more sizes of the shipping units;
determine, using the trained machine learning model, a count of each of the one or more sizes of the shipping units;
determine, using the trained machine learning model and the count, an estimated time when the shipping storage container will be ready for dispatch; and
transmit a notification indicating the estimated time to an electronic device associated with a carrier to cause the carrier to start preparation to pick up the shipping storage container at the storage facility.

2. The system of claim 1, wherein the control circuit is configured to execute the computer-implemented code to group, using the trained machine learning model, the data into at least one of a quantity of the shipping units, total weight of the shipping units, total volume of the shipping units, a day of a week, the week of a year, and a number of scheduled dispatch appointments to create each corresponding quantity data, total weight data, total volume data, day data, week data, and number of scheduled dispatch appointment data.

3. The system of claim 1, wherein a size of a shipping unit comprises small, medium, and large.

4. The system of claim 1, wherein the shipping units corresponds to at least one of first units already loaded in the shipping storage container and second units not loaded in the shipping storage container.

5. The system of claim 1, wherein the shipping storage container comprises a trailer.

6. The system of claim 1, wherein the control circuit is configured to execute the computer-implemented code to determine, using the trained machine learning model, the estimated time using a predetermined percent value of a percentile table, the predetermined percent value corresponding to a respective percentage that the shipping storage container is loaded with the shipping units relative to a total quantities of the shipping units to be loaded.

7. The system of claim 6, wherein the percentile table comprises a percentile range.

8. The system of claim 7, wherein each percent value in the percentile range is a factor of ten.

9. The system of claim 7, further comprising a second control circuit configured to assign a confidence level corresponding to a first difference between the estimated time and a first actual time the shipping storage container is ready for dispatch.

10. The system of claim 9, wherein the second control circuit is further configured to:
for each percent value in the percentile range:
associate the confidence level with the respective percentage that the shipping storage container is loaded with the shipping units relative to the total quantities of the shipping units to be loaded; and
update the percentile table based on the associated confidence level, wherein a transmission of the notification is based in part on the associated confidence level.

11. A computer-implemented method for predicting when a shipping storage container is closed and ready to be dispatched from a storage facility, the method comprising:
receiving, at a control circuit, a set of shipping units data corresponding to the shipping storage container to be loaded with shipping units before the shipping storage container can be dispatched from the storage facility;
grouping, using a trained machine learning model of the control circuit, the set of shipping units data into size data, the size data indicating one or more sizes of the shipping units;
determining, using the trained machine learning model, a count of each of the one or more sizes of the shipping units;
determining, using the trained machine learning model and based at least on the count, an estimated time when the shipping storage container will be ready for dispatch; and
transmitting a notification indicating the estimated time to an electronic device associated with a carrier to cause the carrier to start preparation to pick up the shipping storage container at the storage facility.

12. The method of claim 11, further comprising grouping, using the trained machine learning model, the data into at least one of a quantity of the shipping units, total weight of the shipping units, total volume of the shipping units, a day of a week, the week of a year, and a number of scheduled dispatch appointments to create each corresponding quantity data, total weight data, total volume data, day data, week data, and number of scheduled dispatch appointment data.

13. The method of claim 11, wherein a size of a shipping unit comprises small, medium, and large.

14. The method of claim 11, wherein the shipping units corresponds to at least one of first units already loaded in the shipping storage container and second units not loaded in the shipping storage container.

15. The method of claim 11, wherein the shipping storage container comprises a trailer.

16. The method of claim 11, further comprising determining, using the trained machine learning model, the estimated time using a predetermined percent value of a percentile table, the predetermined percent value corresponding to a respective percentage that the shipping storage container is loaded with the shipping units relative to a total quantities of the shipping units to be loaded.

17. The method of claim 16, wherein the percentile table comprises a percentile range.

18. The method of claim 17, wherein each percent value in the percentile range is a factor of ten.

19. The method of claim 17, further comprising assigning a confidence level corresponding to a first difference between the estimated time and a first actual time the shipping storage container is ready for dispatch.

20. The method of claim 19, further comprising:
for each percent value in the percentile range:
associating the confidence level with the respective percentage that the shipping storage container is loaded with the shipping units relative to the total quantities of the shipping units to be loaded; and
updating the percentile table based on the associated confidence level, wherein a transmission of the notification is based in part on the associated confidence level.
